(19) United States
(12) Patent Application Publication
(10) Pub. No.: US 2026/0005804 A1
(43) Pub. Date: Jan. 1, 2026

(54) COMMUNICATION METHOD AND COMMUNICATION APPARATUS

(71) Applicant: HUAWEI TECHNOLOGIES CO., LTD., Shenzhen (CN)

(72) Inventors: Fan Wei, Shenzhen (CN); Lei Wang, Shenzhen (CN)

(73) Assignee: HUAWEI TECHNOLOGIES CO., LTD., Shenzhen (CN)

(21) Appl. No.: 19/321,591

(22) Filed: Sep. 8, 2025

Related U.S. Application Data
(63) Continuation of application No. PCT/CN2023/080762, filed on Mar. 10, 2023.

(51) Int. Cl. H04L 5/00; H04L 1/00

(52) U.S. Cl. CPC H04L 5/0016; H04L 1/0057

(57) ABSTRACT

This application provides a communication method and a communication apparatus. In the method, a first device determines a scrambling code sequence and a resource block in current transmission based on a mapping relationship between a scrambling code sequence set and a resource block set in the current transmission and a to-be-transmitted information bit. This helps avoid collisions among users by preventing them from using same scrambling code sequences and resource blocks in every transmission. The first device scrambles the information bit based on the scrambling code sequence, to obtain scrambled data in the current transmission, and sends the scrambled data on the resource block. Codeword weight of the scrambled data is within a preset range, allowing the first device to adjust the codeword weight of the scrambled data, thereby enhancing a check capability of a receive end.

### CROSS-REFERENCE TO RELATED APPLICATIONS

This application is a continuation of International Application No. PCT/CN2023/080762, filed on Mar. 10, 2023, the disclosure of which is hereby incorporated by reference in its entirety.

### TECHNICAL FIELD

This application relates to the field of communication technologies, and in particular, to a communication method and a communication apparatus.

### BACKGROUND

A backscatter communication system usually includes an exciter, a tag for reflecting a signal, and a reader. Unlike a conventional active communication mode (in which a sender actively generates electromagnetic waves and modulates the waves for signal transmission based on the electromagnetic waves), backscatter communication uses another mode in which the sender (for example, the tag) does not need to actively generate signals but instead reflects electromagnetic waves generated by another device (for example, the exciter) for communication. However, the modulation scheme currently used by backscatter is only applicable to data transmission of a single-user scenario. When there are a plurality of tags reflecting excitation signals in a network, a receive end cannot demodulate a superposed signal from the plurality of tags.

### SUMMARY

This application provides a communication method and a communication apparatus. The method helps a receive end demodulate a superposed signal from a plurality of devices, to improve a check capability of the receive end.

According to a first aspect, this application provides a communication method, and the method is performed by a first device. The first device may be a terminal device, may be a component (for example, a processor, a chip, or a chip system) of the terminal device, or may be a logical module that can implement all or a part of functions of the terminal device. The first device determines a scrambling code sequence and a resource block in current transmission based on a mapping relationship between a scrambling code sequence set and a resource block set in the current transmission and a to-be-transmitted information bit. The first device scrambles the information bit based on the scrambling code sequence, to obtain scrambled data in the current transmission, and sends the scrambled data on the resource block. Codeword weight of the scrambled data is within a preset range.

In the method, the first device may determine, based on the mapping relationship, a scrambling code sequence and a corresponding resource block that are used for each transmission. This helps avoid collisions among users by preventing them from using same scrambling code sequences and resource blocks in every transmission. In addition, the first device may scramble the information bit based on the selected scrambling code sequence, to adjust the codeword weight of the scrambled data. This helps improve a check capability of a receive end.

In an embodiment, the scrambling code sequence includes a part corresponding to a resource block sequence number and a padding part.

In an embodiment, a length of the part corresponding to the resource block sequence number is log₂(R), a length of the padding part is n−log₂(R), R is a quantity of resource blocks, and n is an information bit length.

In the foregoing method, the scrambling code sequence may be divided into the two parts, and a length of each part is related to the quantity of resource blocks and/or the information bit length, so that the codeword weight of the scrambled data is within the preset range, to help improve the check capability of the receive end.

In an embodiment, an upper limit of the preset range is less than or equal to log₂(R)/2+Δ. Δ=n−log₂(R), R is the quantity of resource blocks, and n is the information bit length.

In an embodiment, a lower limit of the preset range is greater than or equal to log₂(R)/2. R is the quantity of resource blocks.

In the foregoing method, a magnitude of the preset range is related to the quantity of resource blocks and/or the information bit length, so that the codeword weight of the scrambled data is within the preset range, to help improve the check capability of the receive end.

In an embodiment, the first device receives first indication information from a second device. The first indication information indicates the mapping relationship between the scrambling code sequence set and the resource block set in the current transmission. The mapping relationship includes at least two different mapping relationships between scrambling code sequence sets and resource block sets.

In the method, the mapping relationship may be indicated by the second device to the first device by using one piece of indication information, so that the first device may determine, based on the mapping relationship, the scrambling code sequence and the corresponding resource block that are used for each transmission. This helps avoid the case in which the users use the same scrambling code sequence and the same resource block in each transmission, to avoid the collision between the users.

In an embodiment, the scrambling code sequence set used in the current transmission is determined based on a scrambling code sequence set used in a previous transmission.

In an embodiment, an x^{th} scrambling code sequence in the scrambling code sequence set used in the current transmission is obtained by performing bit cyclic shift based on a y^{th} scrambling code sequence in the scrambling code sequence set used in the previous transmission, and the x^{th} scrambling code sequence and the y^{th} scrambling code sequence correspond to a same resource block.

In the foregoing method, different scrambling code sequences are constructed in a bit cyclic shift manner, so that regrouping between the users can be implemented. This helps avoid the case in which the users use the same scrambling code sequence and the same resource block in each transmission, to avoid the collision between the users.

In an embodiment in which the first device scrambles the information bit based on the scrambling code sequence in the current transmission, to obtain the scrambled data in the current transmission, the first device maps, to the resource block corresponding to the scrambling code sequence, encoded data that is in the current transmission and that is obtained through scrambling and encoding, and sends the data in the current transmission on the resource block through on-off modulation. In an embodiment, the first device may further perform modulation processing in another modulation scheme.

According to a second aspect, this application provides another communication method, and the method is performed by a second device. The second device may be a network device (or referred to as an access network device), may be a component (for example, a processor, a chip, or a chip system) of the network device, or may be a logical module that can implement all or a part of functions of the network device. The second device receives data on a plurality of resource blocks included in a resource block set. The second device determines an information bit based on a resource block on which scrambled data is received and a mapping relationship between a scrambling code sequence set and a resource block set in current transmission.

In the method, the second device may receive data on a plurality of resource blocks, and descramble the scrambled data based on the resource block on which the scrambled data is received and the mapping relationship between the scrambling code sequence set and the resource block set in the current data transmission, to obtain the information bit, so as to implement scrambling of a superposed signal from a plurality of devices.

In an embodiment, before the second device determines the information bit, the second device determines the mapping relationship between the scrambling code sequence set and the resource block set in the current transmission based on energy detection and the scrambled data corresponding to a resource block sequence number of the received scrambled data.

In the method, the second device may process the received scrambled data according to an energy detection method, to determine the mapping relationship between the scrambling code sequence set and the resource block set corresponding to the scrambled data.

In an embodiment, any scrambling code sequence in the scrambling code sequence set includes a part corresponding to a resource block sequence number and a padding part.

In an embodiment, a length of the part corresponding to the resource block sequence number is log₂(R), a length of the padding part is n−log₂(R), R is a quantity of resource blocks, and n is an information bit length.

In the foregoing method, the scrambling code sequence may be divided into the two parts, and a length of each part is related to the quantity of resource blocks and/or the information bit length, so that codeword weight of the scrambled data is within a preset range, to help improve a check capability of a receive end (for example, the second device).

In an embodiment, an upper limit of the preset range is less than or equal to log₂(R)/2+Δ. Δ=n−log₂(R), R is the quantity of resource blocks, and n is the information bit length.

In an embodiment, a lower limit of the preset range is greater than or equal to log₂(R)/2. R is the quantity of resource blocks.

In the foregoing method, a magnitude of the preset range is related to the quantity of resource blocks and/or the information bit length, so that the codeword weight of the scrambled data is within the preset range, to help improve the check capability of the receive end (for example, the second device).

In an embodiment, the second device sends first indication information to a first device. The first indication information indicates the mapping relationship between the scrambling code sequence set and the resource block set in the current transmission.

In the method, the mapping relationship may be indicated by the second device to the first device by using one piece of indication information. This helps the first device determine, based on the mapping relationship, a scrambling code sequence and a corresponding resource block that are used for each transmission, and helps avoid collisions among users by preventing them from using same scrambling code sequences and resource blocks in every transmission.

In an embodiment, the scrambling code sequence set used in the current transmission is determined based on a scrambling code sequence set used in a previous transmission.

In an embodiment, an x^{th} scrambling code sequence in the scrambling code sequence set used in the current transmission is obtained by performing bit cyclic shift based on a y^{th} scrambling code sequence in the scrambling code sequence set used in the previous transmission, and the x^{th} scrambling code sequence and the y^{th} scrambling code sequence correspond to a same resource block.

In the foregoing method, different scrambling code sequences are constructed in a bit cyclic shift manner, so that regrouping between the users can be implemented. This helps avoid the case in which the users use the same scrambling code sequence and the same resource block in each transmission, to avoid the collision between the users.

According to a third aspect, this application provides a communication apparatus. The communication apparatus may be a terminal device, may be an apparatus in a terminal device, or may be an apparatus that can be used together with a terminal device. In an embodiment, the communication apparatus may include a functional module. The functional module may be implemented by a hardware circuit, software, or a combination of a hardware circuit and software.

In an embodiment, the communication apparatus may include a processing unit and a communication unit. The processing unit is configured to determine a scrambling code sequence and a resource block in current transmission based on a mapping relationship between a scrambling code sequence set and a resource block set in the current transmission and a to-be-transmitted information bit. The processing unit is further configured to scramble the information bit based on the scrambling code sequence, to obtain scrambled data in the current transmission. Codeword weight of the scrambled data is within a preset range. The communication unit is configured to send the scrambled data on the resource block.

In an embodiment, the scrambling code sequence includes a part corresponding to a resource block sequence number and a padding part.

In an embodiment, a length of the part corresponding to the resource block sequence number is log₂(R), a length of the padding part is n−log₂(R), R is a quantity of resource blocks, and n is an information bit length.

In an embodiment, an upper limit of the preset range is less than or equal to log₂(R)/2+Δ. Δ=n−log₂(R), R is the quantity of resource blocks, and n is the information bit length.

In an embodiment, a lower limit of the preset range is greater than or equal to log₂(R)/2. R is the quantity of resource blocks.

In an embodiment, the communication unit is configured to receive first indication information from a second device. The first indication information indicates the mapping relationship between the scrambling code sequence set and the resource block set in the current transmission. The mapping relationship includes at least two different mapping relationships between scrambling code sequence sets and resource block sets.

In an embodiment, the scrambling code sequence set used in the current transmission is determined based on a scrambling code sequence set used in a previous transmission.

In an embodiment, an x^{th} scrambling code sequence in the scrambling code sequence set used in the current transmission is obtained by performing bit cyclic shift based on a y^{th} scrambling code sequence in the scrambling code sequence set used in the previous transmission, and the x^{th} scrambling code sequence and the y^{th} scrambling code sequence correspond to a same resource block.

According to a fourth aspect, this application provides another communication apparatus. The communication apparatus may be a network device, may be an apparatus in a network device, or may be an apparatus that can be used together with a network device. In an embodiment, the communication apparatus may include a functional module. The functional module may be implemented by a hardware circuit, software, or a combination of a hardware circuit and software.

In an embodiment, the communication apparatus may include a processing unit and a communication unit. The communication unit is configured to receive data on a plurality of resource blocks included in a resource block set. The processing unit is configured to determine an information bit based on a resource block on which scrambled data is received and a mapping relationship between a scrambling code sequence set and a resource block set in current transmission.

In an embodiment, before a second device determines the information bit, the processing unit is further configured to determine the mapping relationship between the scrambling code sequence set and the resource block set in the current transmission based on energy detection and the scrambled data corresponding to a resource block sequence number of the received scrambled data.

In an embodiment, any scrambling code sequence in the scrambling code sequence set includes a part corresponding to a resource block sequence number and a padding part.

In an embodiment, a length of the part corresponding to the resource block sequence number is log₂(R), a length of the padding part is n−log₂(R), R is a quantity of resource blocks, and n is an information bit length.

In an embodiment, an upper limit of a preset range is less than or equal to log₂(R)/2+Δ. Δ=n−log₂(R), R is the quantity of resource blocks, and n is the information bit length.

In an embodiment, a lower limit of the preset range is greater than or equal to log₂(R)/2. R is the quantity of resource blocks.

In an embodiment, the communication unit is further configured to send first indication information to a first device. The first indication information indicates the mapping relationship between the scrambling code sequence set and the resource block set in the current transmission.

In an embodiment, the scrambling code sequence set used in the current transmission is determined based on a scrambling code sequence set used in a previous transmission.

In an embodiment, an x^{th} scrambling code sequence in the scrambling code sequence set used in the current transmission is obtained by performing bit cyclic shift based on a y^{th} scrambling code sequence in the scrambling code sequence set used in the previous transmission, and the x^{th} scrambling code sequence and the y^{th} scrambling code sequence correspond to a same resource block.

For the third aspect or the fourth aspect, in an example, the processing unit may be a processor, and the communication unit may be a transceiver unit, a transceiver, or a communication interface. It may be understood that when the communication apparatus is a communication device (for example, a terminal device or a network device), the communication unit may be a transceiver in the communication apparatus, for example, implemented by using an antenna, a feeder, and a codec in the communication apparatus. Alternatively, if the communication apparatus is a chip disposed in a device, the processing unit may be a processing circuit, a logic circuit, or the like of the chip, and the communication unit may be an input/output interface of the chip, for example, an input/output circuit or a pin.

According to a fifth aspect, this application provides a communication apparatus. The communication apparatus includes a processor, configured to execute instructions. In an embodiment, the communication apparatus further includes a memory. The memory is configured to store the instructions. When the instructions are executed by the processor, the communication apparatus is caused to implement the method according to any one of the first aspect and the possible implementations of the first aspect. In an embodiment, the processor is coupled to the memory.

According to a sixth aspect, this application provides another communication apparatus. The communication apparatus includes a processor, configured to execute instructions. In an embodiment, the communication apparatus further includes a memory. The memory is configured to store the instructions. When the instructions are executed by the processor, the communication apparatus is caused to implement the method according to any one of the second aspect and the possible implementations of the second aspect. In an embodiment, the processor is coupled to the memory.

According to a seventh aspect, this application provides a communication system. The communication system includes the plurality of apparatuses or devices according to the third aspect to the sixth aspect. The apparatuses or devices are caused to perform the method according to any one of the first aspect, the second aspect, and the possible implementations of the first aspect and the second aspect.

According to an eighth aspect, this application provides a computer-readable storage medium. The computer-readable storage medium stores instructions. When the instructions are run on a computer, the computer is caused to perform the method according to any one of the first aspect, the second aspect, and the possible implementations of the first aspect and the second aspect.

According to a ninth aspect, this application provides a chip system. The chip system includes a processor and an interface, and in an embodiment, may further include a memory. The chip system is configured to implement the method according to any one of the first aspect, the second aspect, and the possible implementations of the first aspect and the second aspect. The chip system may include a chip, or may include a chip and another discrete component.

According to a tenth aspect, this application provides a computer program product, including instructions. When the instructions are run on a computer, the computer is caused to perform the method according to any one of the first aspect, the second aspect, and the possible implementations of the first aspect and the second aspect.

### BRIEF DESCRIPTION OF DRAWINGS

FIG. 1a is a diagram of a communication system according to this application;

FIG. 1b is a diagram of another communication system according to this application;

FIG. 2 is a diagram of a backscatter communication system;

FIG. 3 is a diagram of on-off modulation of a backscatter communication system;

FIG. 4 is a schematic flowchart of a communication method according to this application;

FIG. 5 is a diagram of a binding relationship between a scrambling sequence and a time-frequency resource block according to this application;

FIG. 6 is a diagram of a scrambling procedure, a resource mapping procedure, and a modulation procedure of a first device according to this application;

FIG. 7 is a diagram of a communication apparatus according to this application; and

FIG. 8 is a diagram of another communication apparatus according to this application.

### DESCRIPTION OF EMBODIMENTS

In embodiments of this application, “/” may indicate an “or” relationship between associated objects. For example, A/B may indicate A or B; and “and/or” may indicate that there are three relationships between the associated objects. For example, A and/or B may indicate the following three cases: Only A exists, both A and B exist, and only B exists, where A and B may be singular or plural. For ease of describing technical solutions in embodiments of this application, in embodiments of this application, words such as “first” and “second” may be used to distinguish between technical features with a same or similar function. The words such as “first” and “second” do not limit a quantity and an execution sequence, and the words such as “first” and “second” do not indicate a definite difference. In embodiments of this application, a word like “example” or “for example” indicates an example, an illustration, or descriptions. Any embodiment or design solution described as “example” or “for example” should not be explained as being more preferred or having more advantages than another embodiment or design solution. The word like “example” or “for example” is used to present a related concept in a manner for ease of understanding.

The following describes the technical solutions in embodiments of this application with reference to the accompanying drawings in embodiments of this application.

To resolve a problem of signal interference between a plurality of users in a backscatter communication scenario, this application provides a communication method. The communication method helps a receive end demodulate a superposed signal from a plurality of devices, to improve a check capability of the receive end.

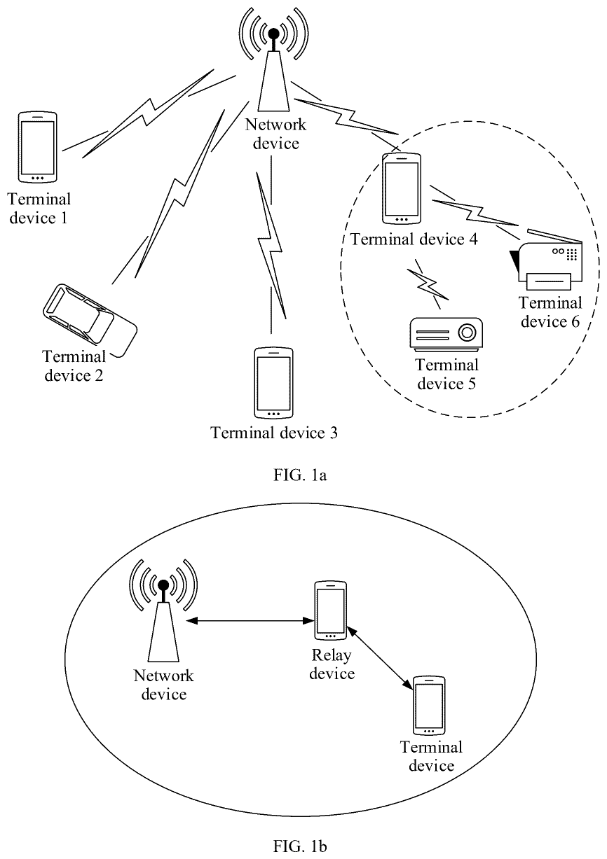

The communication method provided in this application may be applied to a communication system shown in FIG. 1a or FIG. 1b. In the communication system, an entity sends information and/or data to another entity, or receives information and/or data sent by another entity; and the another entity receives the information and/or the data, and sends the information and/or the data to the entity. For example, as shown in FIG. 1a, the communication system includes a network device and terminal devices. The network device and a terminal device 1 to a terminal device 6 form a communication system. In the communication system, the terminal device 1 to the terminal device 6 may send uplink data to the network device, and the network device may receive the uplink data sent by the terminal device 1 to the terminal device 6. In addition, the network device may send information and/or downlink data to the terminal device 1 to the terminal device 6. In an embodiment, the terminal device 4 to the terminal device 6 may also form a communication system. For example, in an internet of vehicles system, the terminal device 5 may send configuration information to the terminal device 4 or the terminal device 6, and receive data sent by the terminal device 4 or the terminal device 6. For another example, as shown in FIG. 1b, the communication system is a single-hop or multi-hop relay system including a relay device. A form of a relay may be a small cell, an integrated access and backhaul (IAB) node, a distributed unit (DU), a terminal, a transmitter and receiver point (TRP), or the like.

The communication system in this application may include, but is not limited to, a communication system using various radio access technologies (RATs), for example, may be an LTE communication system, a 5G (or referred to as new radio (NR)) communication system, or a transition system between an LTE communication system and a 5G communication system, where the transition system may also be referred to as a 4.5G communication system. It is clear that the communication system may alternatively be a future communication system, for example, a 6th generation (6G) or even a 7th generation (7G) system. A network architecture and a service scenario described in embodiments of this application are intended to describe the technical solutions in embodiments of this application more clearly, and do not constitute a limitation on the technical solutions provided in embodiments of this application. One of ordinary skilled in the art may know that with evolution of communication network architectures and emergence of new service scenarios, the technical solutions provided in embodiments of this application are also applicable to similar technical problems.

A terminal device, also referred to as user equipment (UE), a mobile station (MS), a mobile terminal (MT), or the like, is a device that provides voice and/or data connectivity for a user, for example, a handheld device or a vehicle-mounted device having a wireless connection function. Currently, for example, the terminal device is a mobile phone, a tablet computer, a notebook computer, a palmtop computer, a mobile internet device (MID), a wearable device, an uncrewed aerial vehicle, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, a terminal device in a 5G network, a terminal device in a future evolved PLMN network, a terminal device in a future communication system, or the like.

The network device in this application is a radio access network (RAN) node (or device) that connects the terminal device to a wireless network, and may also be referred to as a base station. For example, the RAN node is a continuously evolved NodeB (gNB), a transmission reception point (TRP), an evolved NodeB (eNB), a radio network controller (RNC), a NodeB (NB), a base station controller (BSC), a base transceiver station (BTS), a home base station (for example, a home evolved NodeB, or a home NodeB, HNB), a baseband unit (BBU), a wireless fidelity (Wi-Fi) access point (AP), a satellite in a satellite communication system, a radio controller in a cloud radio access network (CRAN) scenario, a wearable device, an uncrewed aerial vehicle, a device in an internet of vehicles (for example, a vehicle-to-everything (V2X) device), a communication device in device-to-device (D2D) communication, or the like. In addition, in a network structure, the network device may include a central unit (CU) node, a DU node, or a RAN device including a CU node and a DU node. The RAN device including the CU node and the DU node splits protocol layers of an eNB in a long term evolution (LTE) system. Functions of some protocol layers are centrally controlled by a CU, functions of some or all of remaining protocol layers are distributed in a DU, and the CU centrally controls the DU. In some deployments of the network device, the CU may be further divided into a CU-control plane (CP), a CU-user plane (UP), and the like. In some other deployments of the network device, the network device may alternatively be an antenna unit (RU) or the like. In still some other deployments of the network device, the network device may alternatively be of an open radio access network (ORAN) architecture or the like. A type of the network device is not limited in this application. For example, when the network device is of the ORAN architecture, the network device in embodiments of this application may be an access network device in an ORAN, a module in an access network device, or the like. In an ORAN system, a CU may also be referred to as an open (O)-CU, a DU may also be referred to as an O-DU, a CU-DU may also be referred to as an O-CU-DU, a CU-UP may also be referred to as an O-CU-UP, and an RU may also be referred to as an O-RU.

I. For ease of understanding, the following describes in detail definitions of related terms in this application.

### 1. Narrowband Internet of Things Technology

The narrowband internet of things (NB-IoT) technology is a cellular-based narrowband internet of things technology, and is also a best connection technology for a low-power wide-area (LPWA) internet of things. The narrowband internet of things technology bears a basic connection task of an intelligent world, for example, a smart home, smart travel, and a smart city, is widely applied to a plurality of aspects such as a smart meter, smart parking, a smart street lamp, smart agriculture, and white goods, and is one of basic connection technologies in a 5G era. In comparison with a conventional GSM, a base station in the NB-IoT can cover a range of 10 kilometers (km), and has a better coverage capability. In addition, each cell in the NB-IoT can support 50,000 terminals and can provide carrier-grade reliable access to stably support an IoT application scenario. However, currently, the NB-IoT technology still has the following disadvantages: (1) Device power consumption is high. Power consumption of an existing NB-IoT terminal module is as follows: Receiving and processing power consumption is tens of milliwatts (mw), transmission and processing power consumption is hundreds of mw, and standby power consumption is about 1 mw. In industries such as a smart meter, a battery cannot be replaced and a device cannot be repeatedly charged. A battery lifespan restricts a lifespan of an entire meter device. In the future, expected device power consumption of a passive internet of things is about 0.1 mw. In addition, energy is supplied in a manner of radio frequency energy collection, heat energy collection, ambient light energy collection, vibration energy collection, or the like, without battery maintenance. (2) Device costs are high. The existing NB-IoT module is expensive. For the passive internet of things, expected costs of a common passive label chip is about 2% of existing costs.

### 2. Backscatter Communication System

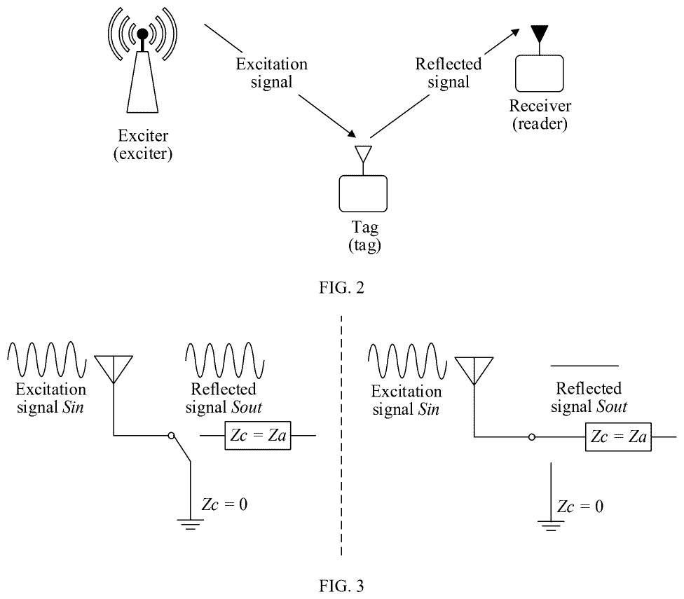

The backscatter communication system usually includes an exciter, a tag for reflecting a signal, and a reader. For example, FIG. 2 is a diagram of a backscatter communication system. The exciter may be the reader or another live network device (for example, a base station or Wi-Fi). In comparison with a conventional active communication mode (for example, a sender actively generates an electromagnetic wave and performs modulation and transmission of a signal based on the electromagnetic wave), backscatter communication uses another mode. In an embodiment, the sender (the tag) does not need to actively generate the signal but reflects an electromagnetic wave generated by another device (for example, the exciter) to perform communication.

Data modulation of backscatter may be performed in an on-off modulation scheme. The on-off modulation scheme includes: When an electromagnetic wave encounters a boundary between two media having different impedances during propagation, the electromagnetic wave is absorbed or reflected back to some extent. Therefore, a backscatter device (for example, the tag) only needs to perform impedance switching at an antenna, to implement information transmission. For example, FIG. 3 is a diagram of on-off modulation of a backscatter communication system. If an excitation signal Sᵢₙ is sent to a tag, a signal Sₒᵤₜ reflected by the tag may be shown in a formula (1):

$${S}_{out} = \sqrt{α} {S}_{in} = \frac{{Z}_{a} - {Z}_{c}}{{Z}_{a} + {Z}_{c}} {S}_{in} \qquad ( 1 )$$

Zₐ and Z_{c} respectively represent impedance of an antenna (generally 50 ohms (Ω)) and impedance corresponding to a circuit connected to the antenna. As shown in FIG. 3, by setting a Z_{c} value of the tag to switch between 0 and Zₐ, two states of the excitation signal may be implemented: an absorbed state and a reflected state, so that a reflected signal has different amplitudes, and different amplitudes may represent different information.

For the backscatter communication system, because no battery is provided on a tag side, energy may be supplied on the tag side in a manner of radio frequency energy collection. For example, a backscatter energy collection manner includes but is not limited to time-switching-based energy collection and power-splitting-based energy collection. For the time-switching-based energy collection, the tag separately performs energy collection and data transmission in different time periods. For the power-splitting-based energy collection, the tag performs energy collection and data transmission at the same time based on a power splitting device. It is assumed that power of the excitation signal is P. When the tag adjusts the impedance Z_{c} to enable the excitation signal to be in the reflected state, αP of the power of the excitation signal is used for transmission of information and (1−α) P of the power of the excitation signal is used to collect energy, where α<1. When the tag adjusts the impedance Z_{c} to enable the excitation signal to be in the absorbed state, the excitation signal is completely used for energy collection on the tag side. A backscatter technology can reduce power consumption of a radio frequency device by several orders of magnitude. Therefore, in some applications of an internet of things, the backscatter technology has great advantages.

II. Communication method provided in this application:

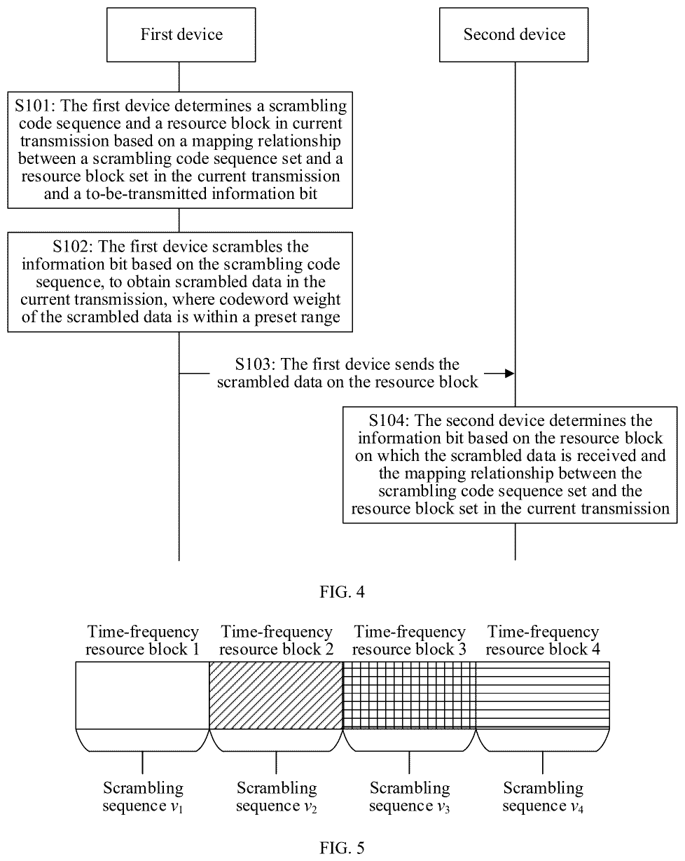

FIG. 4 is a schematic flowchart of a communication method according to this application. The communication method is applied to the communication system shown in FIG. 1a, FIG. 1b, or FIG. 2. For example, the communication method may be implemented through interaction between a first device (for example, a terminal device) and a second device (for example, a network device). In an embodiment, both the first device and the second device may be terminal devices. The communication method includes the following operations.

S101: The first device determines a scrambling code sequence and a resource block in current transmission based on a mapping relationship between a scrambling code sequence set and a resource block set in the current transmission and a to-be-transmitted information bit.

S102: The first device scrambles the information bit based on the scrambling code sequence, to obtain scrambled data in the current transmission, where codeword weight of the scrambled data is within a preset range.

The first device may perform data transmission for a plurality of times, and an information bit transmitted each time is the same, but used mapping relationships between scrambling code sequence sets and resource block sets are different. It is assumed that a total quantity of transmission times is L, and a transmission is represented by m. In this case, the current transmission may be referred to as an m^{th} transmission, and a previous transmission may be referred to as an (m−1)^{th} transmission, where m, m−1, and L are all positive integers, and m≤L. For example, the first device may perform L times of transmission, and each transmission uses a different mapping relationship between a scrambling code sequence set and a resource block set. In an embodiment, a mapping relationship that is between a scrambling code sequence set and a resource block set and that is used for an m^{th} transmission in the L times of transmission is different from a mapping relationship that is between a scrambling code sequence set and a resource block set and that is used for an (m−1)^{th} transmission. When each transmission uses a different mapping relationship between a scrambling code sequence set and a resource block set, even if a plurality of users collide on a same resource block in a transmission, a user that collides in a next transmission uses a new mapping relationship between a scrambling code sequence set and a resource block set, so that a different resource block is selected, and a continuous collision of a plurality of users in each transmission can be avoided. In addition, because the information bit transmitted each time is the same, even if a plurality of users collide on a same resource block in a transmission, a receive end may perform descrambling based on scrambled data received at another time, to recover the information bit. In an embodiment, in this application, first transmission may be referred to as initial transmission, and a transmission other than the first transmission may be referred to as retransmission. For example, it is assumed that the first device repeats transmission of the information bit for L times. The information bit is the same in initial transmission or retransmission.

In an embodiment, to randomize inter-user interference, different scrambling code codebooks need to be used for different times of transmission, and in each transmission, there is a different mapping relationship between a scrambling code sequence set and a resource block set. The following describes in detail a mapping relationship between a scrambling code sequence, a resource block sequence number, a scrambling code sequence set, and a resource block set.

The scrambling code sequence includes a part corresponding to the resource block sequence number and a padding part. In other words, the scrambling code sequence may be constructed based on the resource block sequence number, so that there is a mapping relationship between the scrambling code sequence set and the resource block set. A length of the part corresponding to the resource block sequence number is log₂(R), a length of the padding part is n−log₂(R), R is a quantity of resource blocks, and n is an information bit length. For example, it is assumed that n=6, R=16, and a 4-bit binary form of each resource block sequence number is {0000; 0001; 0010; . . . ; 1111}. In other words, a set including parts corresponding to resource block sequence numbers may be represented as {0000; 0001; 0010; . . . ; 1111}, and a length of a part corresponding to each resource block sequence number is log₂(R)=log₂(16)=4. A length of each padding part is n−log₂(R)=6−log₂(16)=2, and each padding part is a 2-bit all-zero sequence. In an embodiment, each padding part may alternatively be any sequence whose length is n−log₂(R) other than an all-zero sequence, and padding parts of R scrambling sequences all use any other same sequence. In an embodiment, the padding part may be padded to any position before, after, or in the middle of the part corresponding to the resource block sequence number. This is not limited in this application. For example, it is assumed that the padding part is padded after the part corresponding to the resource block sequence number. The scrambling code sequence set may be represented as {000000; 000100; 001000; . . . ; 111100}. The mapping relationship between the scrambling code sequence set and the resource block set is shown in Table 1.

TABLE 1
Mapping relationship between a scrambling code sequence set and a resource block set

| | Resource block sequence number | | | | | | | |
|---|---|---|---|---|---|---|---|---|
| | 0 | 1 | 2 | 3 | 4 | 5 | 6 | 7 |
| Scrambling | 000000 | 000100 | 001000 | 001100 | 010000 | 010100 | 011000 | 011100 |
| code sequence | | | | | | | | |
| | Resource block sequence number | | | | | | | |
| | 8 | 9 | 10 | 11 | 12 | 13 | 14 | 15 |
| Scrambling | 100000 | 100100 | 101000 | 101100 | 110000 | 110100 | 111000 | 111100 |
| code sequence | | | | | | | | |

The mapping relationship between the scrambling code sequence set and the resource block set includes at least two different mapping relationships. For example, the mapping relationship between the scrambling code sequence set and the resource block set in the m^{th} transmission is different from the mapping relationship between the scrambling code sequence set and the resource block set in the (m−1)^{th} transmission. This helps avoid a continuous collision of a plurality of users in each transmission. In an embodiment, the scrambling code sequence set used in the current transmission is determined based on the scrambling code sequence set used in the previous transmission. In an embodiment, an x^{th} scrambling code sequence in the scrambling code sequence set used in the current transmission is obtained by performing bit cyclic shift based on a y^{th} scrambling code sequence in the scrambling code sequence set used in the previous transmission, and the x^{th} scrambling code sequence and the y^{th} scrambling code sequence correspond to a same resource block. The bit cyclic shift may be right bit cyclic shift, or may be left bit cyclic shift. This is not limited in this application. For example, it is assumed that the mapping relationship between the scrambling code sequence set and the resource block set in the (m−1)^{th} transmission is shown in Table 1. If the scrambling code sequences in Table 1 are separately cyclically shifted to the right by one bit, the mapping relationship between the scrambling code sequence set and the resource block set in the m^{th} transmission may be obtained, as shown in Table 2.

TABLE 2
Another mapping relationship between a scrambling
code sequence set and a resource block set

| | Resource block sequence number | | | | | | | |
|---|---|---|---|---|---|---|---|---|
| | 0 | 1 | 2 | 3 | 4 | 5 | 6 | 7 |
| Scrambling | 000000 | 000010 | 000100 | 000110 | 001000 | 001010 | 001100 | 001110 |
| code sequence | | | | | | | | |
| | Resource block sequence number | | | | | | | |
| | 8 | 9 | 10 | 11 | 12 | 13 | 14 | 15 |
| Scrambling | 010000 | 010010 | 010100 | 010110 | 011000 | 011010 | 011100 | 011110 |
| code sequence | | | | | | | | |

It can be learned that, in Table 1 and Table 2, scrambling code sequences corresponding to a same resource block sequence number are different. In other words, the mapping relationship between the scrambling code sequence set and the resource block set in the m^{th} transmission is different from the mapping relationship between the scrambling code sequence set and the resource block set in the (m−1)^{th} transmission.

In an embodiment, the mapping relationship between the scrambling code sequence set and the resource block set may also be represented as a binding relationship between a scrambling sequence and a time-frequency resource block. For example, FIG. 5 is a diagram of a binding relationship between a scrambling sequence and a time-frequency resource block according to this application. It is assumed that sequence numbers of time-frequency resource blocks are 1 to 4 (there are four time-frequency resource blocks in total), and scrambling sequences are respectively v₁, v₂, v₃, and v₄. Scrambled data generated based on each scrambling sequence may be mapped to a corresponding resource block for transmission, as shown in FIG. 5. For example, if a scrambling code sequence in the m^{th} transmission is v₂, scrambling code data in the m^{th} transmission is mapped to a time-frequency resource block 2 for transmission.

In an embodiment, the mapping relationship between the scrambling code sequence set and the resource block set may be preconfigured by the first device, or may be indicated by the second device to the first device. For example, before S101, the method further includes the following operation: The first device receives first indication information from the second device, where the first indication information indicates the mapping relationship between the scrambling code sequence set and the resource block set in the current transmission. Alternatively, the first indication information indicates a plurality of mapping relationships between scrambling code sequence sets and resource block sets, and the first device may search the plurality of mapping relationships for an applicable mapping relationship based on the to-be-transmitted information bit.

The following describes, by using an example, that the mapping relationship between the scrambling code sequence set and the resource block set is constructed by the second device and indicated to the first device. For example, in the first transmission, the second device may construct a mapping relationship between a scrambling code sequence set and a resource block set in the first transmission. First, the second device may set initial parameters. It is assumed that the initial parameters include: an information bit length n=6, a quantity R=16 of resource blocks, a quantity L≥2 of transmission times, and a lower limit a=2 and an upper limit b=4 of codeword weight of a scrambled information bit. Then, the second device may determine log₂(R)-bit binary forms of R resource block sequence numbers. For example, for R=16, a 4-bit binary form of each resource block sequence number is {0000; 0001; 0010; . . . ; 1111}. Then, during the first transmission, for an information bit whose length is n, an n−log₂(R)-bit all-zero sequence is added after the resource block sequence number is constructed, to obtain a scrambling code sequence corresponding to each resource block. For example, Table 3 shows scrambling sequences and scrambled transmission bits corresponding to R=16 resource blocks in the first transmission.

TABLE 3
Scrambling sequences and scrambled transmission bits corresponding
to R = 16 resource blocks in the first transmission

| | Resource block sequence number | | | | | | | |
|---|---|---|---|---|---|---|---|---|
| | 0 | 1 | 2 | 3 | 4 | 5 | 6 | 7 |
| Scrambling | 000000 | 000100 | 001000 | 001100 | 010000 | 010100 | 011000 | 011100 |
| code sequence | | | | | | | | |
| Information | 110000 | 110100 | 111000 | 111100 | 100000 | 100100 | 101000 | 101100 |
| bit | 001101 | 001001 | 000101 | 000001 | 011101 | 011001 | 010101 | 010001 |
| | 101010 | 101110 | 100010 | 100110 | 111010 | 111110 | 110010 | 110110 |
| | 010111 | 010011 | 011111 | 011011 | 000111 | 000011 | 001111 | 001011 |
| Scrambled bit | 110000 | 110000 | 110000 | 110000 | 110000 | 110000 | 110000 | 110000 |
| | 001101 | 001101 | 001101 | 001101 | 001101 | 001101 | 001101 | 001101 |
| | 101010 | 101010 | 101010 | 101010 | 101010 | 101010 | 101010 | 101010 |
| | 010111 | 010111 | 010111 | 010111 | 010111 | 010111 | 010111 | 010111 |
| | Resource block sequence number | | | | | | | |
| | 8 | 9 | 10 | 11 | 12 | 13 | 14 | 15 |
| Scrambling | 100000 | 100100 | 101000 | 101100 | 110000 | 110100 | 111000 | 111100 |
| code sequence | | | | | | | | |
| Information | 010000 | 010100 | 011000 | 011100 | 000000 | 000100 | 001000 | 001100 |
| bit | 101101 | 101001 | 100101 | 100001 | 111101 | 111001 | 110101 | 110001 |
| | 001010 | 001110 | 000010 | 000110 | 011010 | 011110 | 010010 | 010110 |
| | 110111 | 110011 | 111111 | 111011 | 100111 | 100011 | 101111 | 101011 |
| Scrambled bit | 110000 | 110000 | 110000 | 110000 | 110000 | 110000 | 110000 | 110000 |
| | 001101 | 001101 | 001101 | 001101 | 001101 | 001101 | 001101 | 001101 |
| | 101010 | 101010 | 101010 | 101010 | 101010 | 101010 | 101010 | 101010 |
| | 010111 | 010111 | 010111 | 010111 | 010111 | 010111 | 010111 | 010111 |

It can be learned that, after the information bits in Table 3 are scrambled by using different scrambling sequences, the obtained scrambled bits meet the lower limit and upper limit of codeword weight after the scrambling. In other words, different information bits are grouped, and each group of information bits is scrambled by using a corresponding scrambling sequence, and transmitted by using a corresponding time-frequency resource block.

For another example, in the m^{th} transmission (m>1), the second device may construct the mapping relationship between the scrambling code sequence set and the resource block set in the m^{th} transmission. The second device may cyclically shift log₂(R)-bit binary bits of the R resource block sequence numbers to the right by t−1 bits, or to the left by t−1 bits. For example, m=2, n=6, R=16, and t=2. Table 4 shows scrambling sequences and scrambled transmission bits corresponding to R=16 resource blocks in the second transmission.

TABLE 4
Scrambling sequences and scrambled transmission bits corresponding
to R = 16 resource blocks in the second transmission

| | Resource block sequence number | | | | | | | |
|---|---|---|---|---|---|---|---|---|
| | 0 | 1 | 2 | 3 | 4 | 5 | 6 | 7 |
| Scrambling | 000000 | 000010 | 000100 | 000110 | 001000 | 001010 | 001100 | 001110 |
| code sequence | | | | | | | | |
| Information | 011000 | 011010 | 011100 | 011110 | 010000 | 010010 | 010100 | 010110 |
| bit | 000111 | 000101 | 000011 | 000001 | 001111 | 001101 | 001011 | 001001 |
| | 110100 | 110110 | 110000 | 110010 | 111100 | 111110 | 111000 | 111010 |
| | 101011 | 101001 | 101111 | 101101 | 100011 | 100001 | 100111 | 100101 |
| Scrambled bit | 011000 | 011000 | 011000 | 011000 | 011000 | 011000 | 011000 | 011000 |
| | 000111 | 000111 | 000111 | 000111 | 000111 | 000111 | 000111 | 000111 |
| | 110100 | 110100 | 110100 | 110100 | 110100 | 110100 | 110100 | 110100 |
| | 101011 | 101011 | 101011 | 101011 | 101011 | 101011 | 101011 | 101011 |
| | Resource block sequence number | | | | | | | |
| | 8 | 9 | 10 | 11 | 12 | 13 | 14 | 15 |
| Scrambling | 010000 | 010010 | 010100 | 010110 | 011000 | 011010 | 011100 | 011110 |
| code sequence | | | | | | | | |
| Information | 001000 | 001010 | 001100 | 001110 | 000000 | 000010 | 000100 | 000110 |
| bit | 010111 | 010101 | 010011 | 010001 | 011111 | 011101 | 011011 | 011001 |
| | 100100 | 100110 | 100000 | 100010 | 101100 | 101110 | 101000 | 101010 |
| | 111011 | 111001 | 111111 | 111101 | 110011 | 110001 | 110111 | 110101 |
| Scrambled bit | 011000 | 011000 | 011000 | 011000 | 011000 | 011000 | 011000 | 011000 |
| | 000111 | 000111 | 000111 | 000111 | 000111 | 000111 | 000111 | 000111 |
| | 110100 | 110100 | 110100 | 110100 | 110100 | 110100 | 110100 | 110100 |
| | 101011 | 101011 | 001011 | 101011 | 101011 | 101011 | 101011 | 101011 |

It can be learned from comparison with Table 3 that, information bits in Table 4 are regrouped. In an embodiment, different scrambling code sequences are used for a same information bit in different times of transmission, to avoid a collision between users during transmission.

Codeword weight of the scrambled information bits is within a preset range, and an upper limit and a lower limit of the preset range are related to a quantity of resource blocks and/or an information bit length. For example, it is assumed that a spacing between the lower limit a and the upper limit b of the preset range is represented as |b−a|=n−log₂(R), where R is the quantity of resource blocks, and n is the information bit length. The lower limit a is determined based on weight of a bit corresponding to a resource block sequence number after the scrambling, and a range of the lower limit a satisfies w_{scramble}∈[0,log₂(R)], and usually may be a=w_{scramble}=log₂(R)/2. In this case, the upper limit is b=a+n−log₂(R)/2=log₂(R)/2+n−log₂(R)/2. That is, the upper limit of the preset range is less than or equal to log₂(R)/2+Δ, Δ=n−log₂(R), and the lower limit of the preset range is greater than or equal to log₂(R)/2.

In an embodiment, if the codeword weight after the scrambling is within the preset range, it indicates that a quantity of symbols “1” in the scrambled data sent by the first device is within the preset range. This helps improve a check capability of the receive end. For example, it is assumed that there are a large quantity of symbols “1” in the to-be-transmitted information bit. In this case, when determining the scrambling code sequence and the resource block, the first device preferentially selects a scrambling code sequence that reduces the quantity of symbols “1” in the scrambled data, to reduce reflected energy and increase energy collected by the first device. For another example, it is assumed that there are a large quantity of symbols “0” in the to-be-transmitted information bit. In this case, when determining the scrambling code sequence and the resource block, the first device preferentially selects a scrambling code sequence that increases a quantity of symbols “1” in the scrambled data, to avoid missing detection. In an embodiment, in the application, an implementation of scrambling the to-be-transmitted information bit by using the scrambling code sequence is performing a bit modulo-2 addition operation on the information bit and the scrambling code sequence.

For example, it is assumed that the to-be-transmitted information bit is u=[110111], and the scrambling code sequence set in the m^{th} transmission is {v₁, v₂, v₃, v₄}, where v₁=000000, v₂=001000, v₃=110111, and v₄=000101. It is assumed that the lower limit of the preset range is 2, and the upper limit of the preset range is 4. The first device traverses the scrambling code sequence set. For example, the first device separately performs the bit modulo-2 addition operation on the to-be-transmitted information bit and v₁, v₂, v₃, and v₄, and finds that a scrambling code sequence v₄ enables the quantity of symbols “1” in the scrambled data to meet the preset range, that is, u⊕v₄=[110010], so that a=2≤#“1”≤b=4. In this case, the first device determines that the scrambling code sequence is v₄, the resource block is a resource block (for example, a time-frequency resource block 4) corresponding to the scrambling code sequence, and the scrambled data is u′=[110010].

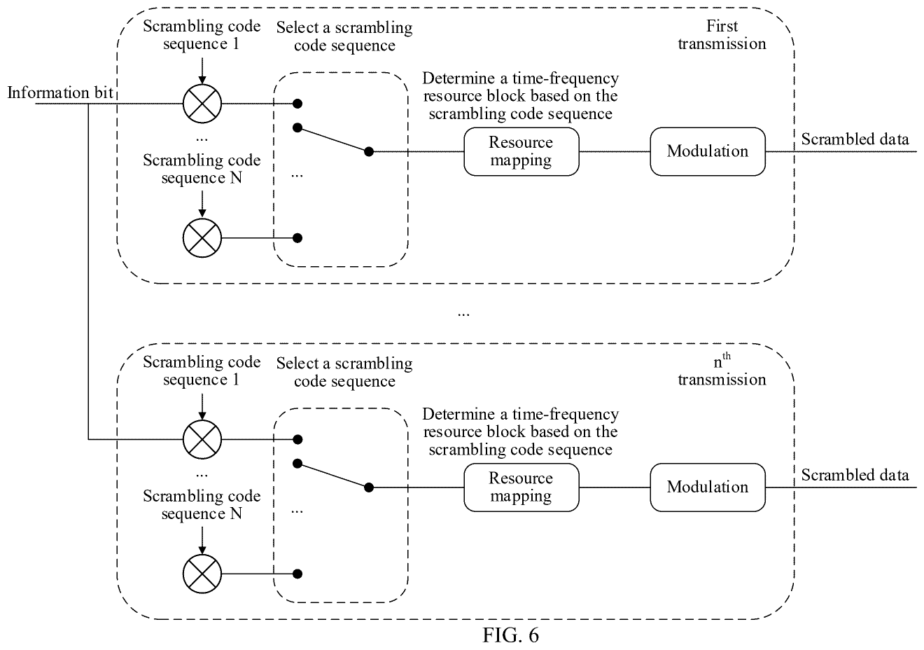

In an embodiment, after determining the scrambling code sequence, the first device may further perform resource mapping and modulation, to obtain to-be-sent scrambled data. For example, FIG. 6 is a diagram of a scrambling procedure, a resource mapping procedure, and a modulation procedure of a first device according to this application. For an m^{th} transmission, the first device may select one scrambling code sequence from a plurality of scrambling code sequences (for example, N scrambling code sequences), determine a time-frequency resource block corresponding to the scrambling code sequence, and map a scrambled information bit to the corresponding time-frequency resource block. Further, as shown in FIG. 6, the first device may perform modulation in an on-off modulation scheme. In an embodiment, the first device may further use another modulation scheme. This is not limited in this application.

S103: The first device sends the scrambled data on the resource block.

For example, in S102, if the first device determines that the scrambling code sequence is v₄, and the corresponding resource block is the time-frequency resource block 4, the first device may scramble the information bit by using the scrambling code sequence v₄, and send the scrambled data on the time domain resource block 4.

Correspondingly, the second device receives data on a plurality of resource blocks included in the resource block set. For example, in the m^{th} transmission, the second device may receive data on all time-frequency resource blocks 1 to 4. It is assumed that a plurality of first devices send data to the second device. In this case, the second device may receive data on a plurality of time-frequency resource blocks.

In an embodiment, the second device may directly determine, based on an energy value of a received signal, an information bit sent by the first device. In other words, the second device may perform energy detection, to determine an information bit included in the received data. For example, it is assumed that the signal received by the second device is represented as y[n]=x[n]+α·B·x[n]+w[n], where x[n] represents an excitation signal, α·B·x[n] represents a reflected signal, α represents a fading coefficient, B∈{0,1} represents an information bit, and w[n] represents a noise signal. The second device may obtain the energy value of the received information based on an energy detector, as shown in a formula (2):

$$\frac{1}{L} {\sum }_{n = 1}^{L} {\vert y [ n ] \vert}^{2} = \frac{{\vert 1 + α B \vert}^{2}}{L} {\sum }_{n = 1}^{L} {\vert x [ n ] \vert}^{2} + \frac{1}{L} {\sum }_{n = 1}^{L} {\vert w [ n ] \vert}^{2} \qquad ( 2 )$$

y[n] represents a signal received by the receive end, and L represents a quantity of transmission times. It is assumed that

$$P = \frac{1}{L} {\sum }_{n = 1}^{M} {\vert x [ n ] \vert}^{2} ,$$

and a noise item is ignored. In this case, the energy value of the received signal may be represented as a formula (3) and a formula (4):

$${\vert 1 + α \vert}^{2} P , B = 1 \qquad ( 3 )$$

$$P , B = 0 \qquad ( 4 )$$

B=1 represents that the first device (a tag side) reflects the excitation signal, and B=0 represents that the tag side absorbs the excitation signal. Therefore, the second device (the receive end) may determine, based on the energy value of the received signal, the information bit sent by the first device (the tag side).

S104: The second device determines the information bit based on the resource block on which the scrambled data is received and a mapping relationship between a scrambling code sequence set and a resource block set in current transmission.

When the second device receives the scrambled data on the resource block, the second device may descramble and/or demodulate the received scrambled data, to determine an original information bit. For example, corresponding to the scrambling and modulation procedures in FIG. 6, the second device may determine, based on the scrambled data corresponding to a resource block sequence number, that current data transmission is the m^{th} time of data transmission, and then obtain the corresponding scrambling code sequence from the mapping relationship between the scrambling code sequence set and the resource block set in the m^{th} transmission. The second device may restore the original information bit based on the scrambling code sequence and the scrambled data.

In an embodiment, if the second device may directly determine, based on the energy value of the received signal, the information bit sent by the first device, the second device may determine the mapping relationship between the code sequence set and the resource block set in the current transmission (that is, determine a value of m) based on the energy detection and the scrambled data corresponding to the resource block sequence number of the received scrambled data. For example, if the energy value of the received signal is shown in formulas (2) to (4), the second device may derive the value of m with reference to the foregoing formulas, to determine the mapping relationship between the scrambling code sequence set and the resource block set, and then obtain the corresponding scrambling code sequence from the mapping relationship between the scrambling code sequence set and the resource block set based on the resource block sequence number of the scrambled data. The second device may restore the original information bit based on the scrambling code sequence and the scrambled data.

It can be learned that the communication method in an embodiment helps avoid collisions among users by preventing them from using same scrambling code sequences and resource blocks in every transmission. In addition, the first device may scramble the information bit based on the selected scrambling code sequence, to adjust codeword weight of the scrambled data. This helps improve the check capability of the receive end.

To implement functions in the method provided in this application, an apparatus or a device provided in this application may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions. Division into modules in this application is an example, and is merely logical function division. In an embodiment, there may be another division manner. In addition, functional modules in embodiments of this application may be integrated into one processor, or may exist alone physically, or two or more modules may be integrated into one module. The integrated module may be implemented in a form of hardware, or may be implemented in a form of a software functional module.

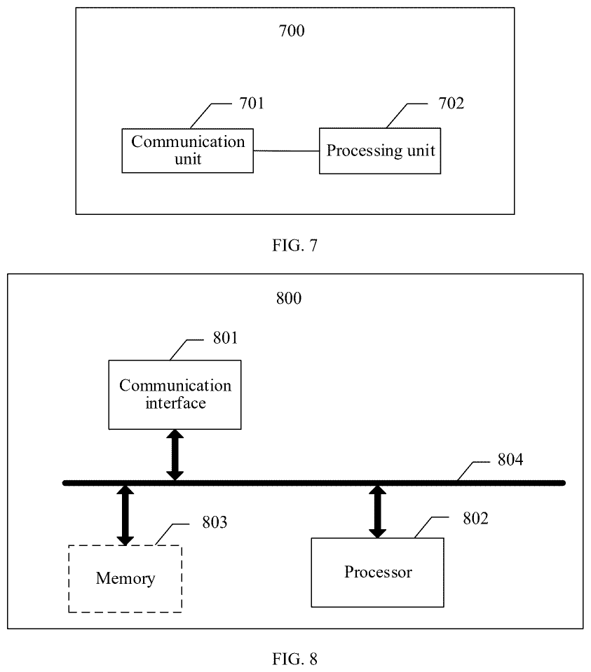

FIG. 7 is a diagram of a communication apparatus according to this application. The apparatus may include modules that are in one-to-one correspondence with the method/operations/steps/actions described in any embodiment shown in FIG. 4 to FIG. 6. The module may be implemented by a hardware circuit, software, or a combination of a hardware circuit and software.

The apparatus 700 includes a communication unit 701 and a processing unit 702, configured to implement the methods performed by each device in the foregoing embodiments.

In an embodiment, the apparatus is a terminal device, or is located in a terminal device. Specifically, the processing unit 702 is configured to determine a scrambling code sequence and a resource block in current transmission based on a mapping relationship between a scrambling code sequence set and a resource block set in the current transmission and a to-be-transmitted information bit. The processing unit 702 is further configured to scramble the information bit based on the scrambling code sequence, to obtain scrambled data in the current transmission, where codeword weight of the scrambled data is within a preset range. The communication unit 701 is configured to send the scrambled data on the resource block.

For specific execution procedures of the communication unit 701 and the processing unit 702 in an embodiment, refer to the descriptions of the operations performed by the first device in the method embodiments provided in the foregoing second part and the corresponding descriptions in the summary. Details are not described herein again. In the communication method implemented by the apparatus, the first device may determine, based on the mapping relationship, a scrambling code sequence and a corresponding resource block that are used for each transmission. This helps avoid collisions among users by preventing them from using same scrambling code sequences and resource blocks in every transmission. In addition, the first device may scramble the information bit based on the selected scrambling code sequence, to adjust the codeword weight of the scrambled data. This helps improve a check capability of a receive end.

In an embodiment, the apparatus is a network device (or referred to as an access network device), or is located in a network device. Specifically, the communication unit 701 is configured to receive data on a plurality of resource blocks included in a resource block set. The processing unit 702 is configured to determine an information bit based on a resource block on which scrambled data is received and a mapping relationship between a scrambling code sequence set and a resource block set in current transmission.

For specific execution procedures of the communication unit 701 and the processing unit 702 in an embodiment, refer to the descriptions of the operations performed by the second device in the method embodiment provided in the foregoing second part and the corresponding descriptions in the summary. Details are not described herein again. In the communication method implemented by the apparatus, the second device may receive data on a plurality of resource blocks, and descramble the scrambled data based on the resource block on which the scrambled data is received and the mapping relationship between the scrambling code sequence set and the resource block set in the current data transmission, to obtain the information bit, so as to implement scrambling of a superposed signal from a plurality of devices.

FIG. 8 is a diagram of another communication apparatus according to this application. The communication apparatus is configured to implement the communication method in the foregoing method embodiments. The apparatus 800 may be a chip system, or may be the device described in the foregoing method embodiments.

The apparatus 800 includes a communication interface 801 and a processor 802. The communication interface 801 may be, for example, a transceiver, an interface, a bus, a circuit, or an apparatus that can implement a transceiver function. The communication interface 801 is configured to communicate with another device through a transmission medium, so that the apparatus 800 may communicate with the another device. The processor 802 is configured to perform a processing-related operation.

In an embodiment, the apparatus is a terminal device, or is located in a terminal device. Specifically, the processor 802 is configured to determine, in current transmission, a scrambling code sequence and a resource block in the current transmission based on a mapping relationship between a scrambling code sequence set and a resource block set in the current transmission and a to-be-transmitted information bit. The processor 802 is further configured to scramble the information bit based on the scrambling code sequence, to obtain scrambled data in the current transmission, where codeword weight of the scrambled data is within a preset range. The communication interface 801 is configured to send the scrambled data on the resource block.

For specific execution procedures of the communication interface 801 and the processor 802 in an embodiment, refer to the descriptions of the operations performed by the terminal device in the method embodiments provided in the foregoing second part and the corresponding descriptions in the summary. Details are not described herein again. In the communication method implemented by the apparatus, a first device may determine, based on the mapping relationship, a scrambling code sequence and a corresponding resource block that are used for each transmission. This helps avoid collisions among users by preventing them from using same scrambling code sequences and resource blocks in every transmission. In addition, the first device may scramble the information bit based on the selected scrambling code sequence, to adjust the codeword weight of the scrambled data. This helps improve a check capability of a receive end.

In an embodiment, the apparatus is a network device, or is located in a network device. Specifically, the communication interface 801 is configured to receive data on a plurality of resource blocks included in a resource block set. The processor 802 is configured to determine an information bit based on a resource block on which scrambled data is received and a mapping relationship between a scrambling code sequence set and a resource block set in current transmission.

For specific execution procedures of the communication interface 801 and the processor 802 in an embodiment, refer to the descriptions of the operations performed by the network device in the method embodiments provided in the foregoing second part and the corresponding descriptions in the summary. Details are not described herein again. In the communication method implemented by the apparatus, a second device may receive data on a plurality of resource blocks, and descramble the scrambled data based on the resource block on which the scrambled data is received and the mapping relationship between the scrambling code sequence set and the resource block set in the current data transmission, to obtain the information bit, so as to implement scrambling of a superposed signal from a plurality of devices.

In an embodiment, the apparatus 800 may further include at least one memory 803, configured to store program instructions and/or data. In an embodiment, the memory is coupled to the processor. The coupling in this application may be an indirect coupling or a communication connection between apparatuses, units, or modules in an electrical form, a mechanical form, or another form, and is used for information exchange between the apparatuses, the units, or the modules. The processor may perform an operation in collaboration with the memory. The processor may execute the program instructions stored in the memory. The at least one memory and the processor are integrated together.

In this application, a specific connection medium between the communication interface, the processor, and the memory is not limited. For example, the memory, the processor, and the communication interface are connected through a bus. A bus 804 is represented by using a thick line in FIG. 8. A manner of a connection between other components is merely an example for description, and is not limited thereto. The bus may be classified into an address bus, a data bus, a control bus, and the like. For ease of representation, only one thick line is used in FIG. 8 for representation, but it does not indicate that there is only one bus or only one type of bus.

In this application, the processor may be a general-purpose processor, a digital signal processor, an application-specific integrated circuit, a field programmable gate array or another programmable logic device, a discrete gate or transistor logic device, or a discrete hardware component, and may implement or perform methods, operations, and logical block diagrams that are disclosed in this application. The general-purpose processor may be a microprocessor or any conventional processor or the like. The operations of the methods disclosed with reference to this application may be directly performed and completed by a hardware processor, or may be performed and completed by a combination of hardware and a software module in the processor.

In this application, the memory may be a non-volatile memory, for example, a hard disk drive (HDD) or a solid-state drive (SSD), or may be a volatile memory, for example, a random access memory (RAM). The memory is any other medium that can carry or store expected program code in a form of instructions or a data structure and that can be accessed by a computer, but is not limited thereto. Alternatively, the memory in this application may be a circuit or any other apparatus that can implement a storage function, and is configured to store program instructions and/or data.

This application provides another communication apparatus. The device includes a processor. In an embodiment, the processor is coupled to a memory, and the processor is configured to read and execute computer instructions stored in the memory, to implement the communication method in embodiments shown in FIG. 4 to FIG. 6.

This application provides a communication system. The communication system includes one or more of the devices in embodiments shown in FIG. 4 to FIG. 6.

This application provides a computer-readable storage medium. The computer-readable storage medium stores a program or instructions. When the program or the instructions are run on a computer, the computer is caused to perform the communication method in embodiments shown in FIG. 4 to FIG. 6.

This application provides a computer program product. The computer program product includes instructions. When the instructions are run on a computer, the computer is caused to perform the communication method in embodiments shown in FIG. 4 to FIG. 6.

This application provides a chip or a chip system. The chip or the chip system includes at least one processor and an interface. The interface and the at least one processor are interconnected through a line. The at least one processor is configured to run a computer program or instructions, to perform the communication method in embodiments shown in FIG. 4 to FIG. 6.

The interface in the chip may be an input/output interface, a pin, a circuit, or the like.

The chip system may be a system on chip (SoC), or may be a baseband chip, or the like. The baseband chip may include a processor, a channel encoder, a digital signal processor, a modem, an interface module, and the like.

In an embodiment, the chip or the chip system described above in this application further includes at least one memory, and the at least one memory stores instructions. The memory may be a storage unit inside the chip, for example, a register or a cache, or may be a storage unit (for example, a read-only memory or a random access memory) of the chip.

All or a part of the technical solutions provided in this application may be implemented by software, hardware, firmware, or any combination thereof. When software is used to implement the technical solutions, all or a part of the technical solutions may be implemented in a form of a computer program product. The computer program product includes one or more computer instructions. When the computer program instructions are loaded and executed on a computer, the procedures or functions according to this application are all or partially generated. The computer may be a general-purpose computer, a dedicated computer, a computer network, a network device, a terminal device, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, that integrates one or more usable media. The usable medium may be a magnetic medium (for example, a floppy disk, a hard disk drive, or a magnetic tape), an optical medium (for example, a digital video disc (DVD)), a semiconductor medium, or the like.

In this application, on the premise that there is no logical conflict, embodiments may be mutually referenced. For example, methods and/or terms may be mutually referenced between method embodiments. For example, functions and/or terms may be mutually referenced between apparatus embodiments. For example, functions and/or terms may be mutually referenced between apparatus embodiments and method embodiments.

It is clear that one of ordinary skilled in the art can make various modifications and variations to this application without departing from the scope of this application. In this way, this application is intended to cover these modifications and variations of this application provided that they fall within the scope of the claims of this application and equivalent technologies thereof.

What is claimed is:

1. A communication method, comprising:
determining, by a first device, a scrambling code sequence and a resource block in current transmission based on a mapping relationship between a scrambling code sequence set and a resource block set in the current transmission and an information bit to be transmitted;
scrambling, by the first device, the information bit based on the scrambling code sequence, to obtain scrambled data in the current transmission, wherein codeword weight of the scrambled data is within a preset range; and
sending, by the first device, the scrambled data on the resource block.

2. The method according to claim 1, wherein the scrambling code sequence comprises a part corresponding to a resource block sequence number and a padding part.

3. The method according to claim 2, wherein a length of the part corresponding to the resource block sequence number is log₂(R), and a length of the padding part is n−log₂(R), wherein R is a quantity of resource blocks, and n is an information bit length.

4. The method according to claim 2, wherein an upper limit of the preset range is less than or equal to log₂(R)/2+Δ, wherein Δ=n−log₂(R), R is a quantity of resource blocks, and n is an information bit length.

5. The method according to claim 2, wherein a lower limit of the preset range is greater than or equal to log₂(R)/2, wherein R is a quantity of resource blocks.

6. The method according to claim 1, wherein the method further comprises:
receiving, by the first device, first indication information from a second device, wherein the first indication information indicates the mapping relationship between the scrambling code sequence set and the resource block set in the current transmission.

7. The method according to claim 1, wherein the scrambling code sequence set used in the current transmission is determined based on a scrambling code sequence set used in a previous transmission.

8. The method according to claim 7, wherein an x^{th} scrambling code sequence in the scrambling code sequence set used in the current transmission is obtained by performing bit cyclic shift based on a y^{th} scrambling code sequence in the scrambling code sequence set used in the previous transmission, and the x^{th} scrambling code sequence and the y^{th} scrambling code sequence correspond to a same resource block.

9. A communication method, comprising:
receiving, by a second device, data on a plurality of resource blocks comprised in a resource block set; and
determining, by the second device, an information bit based on a resource block on which scrambled data is received and a mapping relationship between a scrambling code sequence set and a resource block set in current transmission.

10. The method according to claim 9, wherein before determining the information bit, the method further comprises:
determining, by the second device, a value of n based on energy detection and the scrambled data corresponding to a resource block sequence number of the received scrambled data.

11. The method according to claim 9, wherein any scrambling code sequence in the scrambling code sequence set comprises a part corresponding to a resource block sequence number and a padding part.

12. The method according to claim 11, wherein a length of the part corresponding to the resource block sequence number is log₂(R), and a length of the padding part is n−log₂(R), wherein R is a quantity of resource blocks, and n is an information bit length.

13. The method according to claim 11, wherein an upper limit of a preset range is less than or equal to log₂(R)/2+Δ, wherein Δ=n−log₂(R), R is the quantity of resource blocks, and n is an information bit length.

14. The method according to claim 11, wherein a lower limit of a preset range is greater than or equal to log₂(R)/2, wherein R is the quantity of resource blocks.

15. The method according to claim 9, wherein the method further comprises:
sending, by the second device, first indication information to a first device, wherein the first indication information indicates the mapping relationship between the scrambling code sequence set and the resource block set in the current transmission.

16. The method according to claim 9, wherein the scrambling code sequence set used in the current transmission is determined based on a scrambling code sequence set used in a previous transmission.

17. The method according to claim 16, wherein an x^{th} scrambling code sequence in the scrambling code sequence set used in the current transmission is obtained by performing bit cyclic shift based on a y^{th} scrambling code sequence in the scrambling code sequence set used in the previous transmission, and the x^{th} scrambling code sequence and the y^{th} scrambling code sequence correspond to a same resource block.

18. A communication apparatus, comprising:
a processor, and
a memory coupled to the processor to store instructions, which when executed by the processor, cause the communication apparatus to:
determine a scrambling code sequence and a resource block in current transmission based on a mapping relationship between a scrambling code sequence set and a resource block set in the current transmission and an information bit to be transmitted;
scramble the information bit based on the scrambling code sequence, to obtain scrambled data in the current transmission, wherein codeword weight of the scrambled data is within a preset range; and
send the scrambled data on the resource block.

19. The apparatus according to claim 18, wherein the scrambling code sequence comprises a part corresponding to a resource block sequence number and a padding part.

20. The apparatus according to claim 19, wherein a length of the part corresponding to the resource block sequence number is log₂(R), and a length of the padding part is n−log₂(R), wherein R is a quantity of resource blocks, and n is an information bit length.
